(19) United States
(12) Patent Application Publication
(10) Pub. No.: US 2025/0062602 A1
(43) Pub. Date: Feb. 20, 2025

(54) ELECTRICAL SUPPLY LINE AND DEVICE HAVING A SUPPLY LINE OF THIS TYPE

(71) Applicant: LEONI Bordnetz-Systeme GmbH, Kitzingen (DE)

(72) Inventors: Jonathan MARKERT, Reichenberg (DE); Bernd SCHNEIDER, Dettelbach (DE)

(21) Appl. No.: 18/720,770

(22) PCT Filed: Dec. 8, 2022
(86) PCT No.: PCT/EP2022/085005

§ 371 Date: Jun. 17, 2024

(30) Foreign Application Priority Data
Dec. 15, 2021 (DE) 10 2021 214 443.8

(51) Int. Cl. H02G 3/04; B60R 16/02; B60R 16/03

(52) U.S. Cl. CPC H02G 3/0468; B60R 16/0215; B60R 16/03

(57) ABSTRACT

An electrical supply line, in particular for a motor vehicle, contains two conductor arrangements for different operating potentials, the conductor arrangements being electrically isolated from each other. The two conductor arrangements are disposed in one conductor layer each and are disposed one over the other. Each conductor arrangement has a plurality of individual conductors. The conductor arrangements are led in a cable duct which forms, for each of the individual conductors, an individual duct with lateral separating pieces. The individual conductors are each disposed between two separating pieces such that the individual conductors are fixed relative to each other.

The present invention relates to an electrical supply line and a device, especially a motor vehicle, having such a supply line. The supply line has two conductor arrangements, electrically isolated from one another, for different operating potentials, wherein the two conductor arrangements are disposed in one conductor layer each and one above the other.

Document DE 10 2012 200 979 A1 describes a supply line of this kind, in which a respective conductor arrangement is designed as a busbar. The supply line is used as a DC line and connects a battery to consumers.

A supply line of this kind is used, for example, as a so-called backbone in a motor vehicle. It can be used both in low-voltage vehicle electrical systems with a vehicle electrical system voltage of 12 V or 48 V or also for high-voltage applications for example in conjunction with electric-motor-driven vehicles with voltages in the region of several 100 V and for example in the range of from 300 V to 1000 V.

In particular at high currents with DC lines, strong magnetic fields may arise, which, in unfavorable cases, may lead to high, inadmissible magnetic fields in the passenger compartment. This problem occurs in particular also in electric-motor-driven vehicles in which a traction battery is disposed beneath the body floor and electrical supply lines are then routed in the passenger compartment. The, otherwise present, shielding effect of the body floor is then absent in this case.

To avoid such interfering magnetic fields and to improve the EMC (electromagnetic compatibility), DE 10 2012 200 979 A1 proposes the specific layered arrangement of the conductor rails.

Proceeding from this basis, the object of the invention is to describe an alternative supply line, in particular for a DC line in a motor vehicle, which has a compact structure and demonstrates good EMC.

The object is achieved in accordance with the invention by an electrical supply line and by a device, in particular motor vehicle, comprising a supply line of this kind. The supply line has two and preferably exactly two conductor arrangements, electrically isolated from one another, for different operating potentials. Specifically, the supply line is designed as a DC line, in which the one supply line is designed as a forward conductor and the other supply line is designed as a return conductor. One supply line is connected here for example to a positive potential of a battery or generally a supply voltage of the vehicle electrical system and the other conductor arrangement is connected to a negative terminal or a ground potential. The two conductor arrangements are disposed in one conductor layer each and in layers one above the other. In principle, it is also possible to dispose a plurality of conductor arrangements in more than two conductor layers. Precisely two conductor layers, however, are preferably provided.

The supply line is distinguished in that each conductor arrangement has a plurality of individual conductors and in that the conductor arrangements are guided in a cable duct, which for each of the individual conductors forms an individual channel with lateral separating ribs, so that the individual conductors are disposed in a stationary manner relative to one another between two separating ribs. The division of a single conductor with a large cross section across a plurality of individual conductors each with a smaller cross section leads, on account of the larger surface of the individual conductors, to an improved heat dissipation.

Due to the contact of the plurality of individual conductors each individually with the cable duct, which is preferably made if plastic, a large contact area is additionally formed between the individual conductors and the cable duct, which contributes additionally to the good heat dissipation, specifically in comparison with air, since the material of the cable duct typically has a better heat conductivity than air.

In this design-compared to the prior art-the use of solid busbars is therefore initially dispensed with. The individual conductor formed by a respective busbar is replaced in the present case by a conductor arrangement which is formed within a conductor layer and which is composed of several individual conductors.

The individual conductors are held in defined positions to ensure good EMC properties and, in particular, to avoid or reduce magnetic fields. They are also arranged as compactly as possible within the cable duct. Both of these factors mean that the magnetic fields generated by the forward conductor and the return conductor during operation are at least partially compensated, so that the remaining resulting magnetic field is at least low. By dividing a respective conductor arrangement into a plurality of individual conductors, an improved EMC is achieved compared to two conductor arrangements routed next to each other and each designed as a single round conductor.

This design with the individual conductors arranged in close proximity to each other in the two conductor layers, through which current flows in opposite directions during operation, is based on the consideration that the magnetic fields of conductors through which current flows in opposite directions compensate each other.

In order to achieve the best possible compensation, it is important that the individual conductors are positioned as precisely and as close to each other as possible. The individual conductors are therefore preferably positioned in the individual channels in each case with a precise fit and therefore without play.

Preferably, the individual conductors are clamped in their respective individual channel. For example, the cable duct has a certain elasticity so that a clamping effect is achieved. Alternatively or additionally, it is also possible for the individual channels to be suitably designed so that the respective individual conductors can be snapped into such an individual channel and are then preferably also held form-fittingly in a respective individual channel.

In a preferred embodiment, exactly one conductor arrangement for exactly one operating potential is arranged in each conductor layer. There is therefore exactly one operating potential within a conductor layer during operation.

For this purpose in particular, it is provided that the individual conductors of a respective conductor arrangement and thus in particular all the individual conductors of a respective conductor layer are electrically connected to each other. The individual conductors of a conductor arrangement/a conductor layer are therefore connected in parallel with each other.

The electrically conductive connection is preferably established via an integrally bonded connection or a mechanical connection of the individual conductors either directly to each other, but preferably via a common contact element. The individual conductors are each electrically conductively connected to the common contact element and are indirectly electrically connected to each other via this. Welding, in particular resistance welding, is used to form the integrally bonded connection. For the mechanical connection, crimping or another conventional mechanical plug-in or screw connection is provided, for example.

The contact element is a stamped part, for example. Furthermore, a conventional contact element such as a contact plug with a common electrical connection for the individual individual conductors can be used. Such a contact plug forms a connector plug for a (plug-in) connection of the supply line to an electrical component, for example to a consumer. Alternatively, the contact element is a connection element, in particular in the form of a cable lug, for example for connection to a connection terminal of a battery.

A cable duct is generally understood to mean a guide element extending in the direction of the conductor arrangements with individual guide channels for the individual conductors. The cable duct extends over a large part of the length of the conductor arrangements, i.e., over at least 50% and preferably over at least 75% of the length of the conductor arrangements. Preferably, the cable duct—apart from any necessary connection regions—extends over the entire length of the conductor arrangements and thus also of the supply line as a whole. In general, the supply line and thus also the cable duct typically have a length of >1 m or even >1.5 m and more.

The cable duct is preferably a one-piece, monolithic cable duct. This is designed in particular as a profile, for example an extrusion profile/extruded profile. At the very least, the cable duct has a monolithic base part that defines the two conductor layers and the individual channels. This base part typically has an intermediate base, from which the separating ribs for the respective individual conductors in the two adjacent conductor layers protrude on both sides.

The individual conductors of a respective conductor layer are preferably arranged within a plane and thus at the same level next to each other—at least when viewed in a cross-section or as a whole.

In a preferred embodiment, the individual conductors are round conductors. These are easy to handle in terms of installation. In particular, the individual conductors are compacted conductors, especially compacted stranded conductors or, alternatively, solid conductors. This results in a compact overall design.

In a preferred embodiment, the individual conductors are bare conductors without insulation. Electrical insulation is provided via the cable duct, in particular via the intermediate base and via the separating ribs.

According to a particularly preferred design, the individual conductors have different conductor cross-sections. This measure enables a particularly compact design and arrangement of the individual conductors in relation to each other.

In particular, it is provided that the (all) individual conductors of one conductor layer have a smaller conductor cross section than the (all) individual conductors of the other conductor layer. The individual conductors of a respective conductor layer preferably have a constant conductor cross section and, in particular, diameter. This results in a flat design.

In order to position the individual conductors, especially those with the small conductor cross section, in defined relative positions, especially in relation to the (larger) individual conductors of the other conductor layer, the cable duct preferably has empty channels that are formed between two adjacent individual channels, in each of which an individual conductor is guided. Preferably, such empty channels are arranged alternately to the individual channels. Furthermore, such empty channels are preferably only formed in one of the conductor layers, preferably only in the conductor layer with the individual conductors with the smaller conductor cross sections.

Especially when the individual conductors are designed as round conductors, the individual conductors are arranged next to each other, forming an intermediate or gusset region. In order to achieve as compact an arrangement as possible and also good EMC properties, the individual conductors of the second conductor layer and thus of the second conductor arrangement are arranged in the region of these gusset regions. This means that the individual conductors of one conductor layer are offset in the transverse direction in relation to the individual conductors in the other conductor layer.

In this embodiment in particular, the number of individual conductors in the two conductor layers is preferably different. In particular, the number of individual conductors in one conductor layer is increased by exactly one compared to the number in the other conductor layer.

Preferably, the entire conductor cross section of each of the two supply lines is identical or at least largely identical. In particular, the two supply lines are designed for the same current-carrying capacity.

As already previously mentioned, the cable duct has an intermediate base that separates the two conductor layers and thus the two conductor arrangements with the multiple individual conductors. According to a first embodiment, the intermediate base is flat—at least when viewed in cross section and preferably over the entire length of the cable duct. In a preferred embodiment, this intermediate base is alternatively corrugated when viewed in cross section, for example sinusoidally corrugated and with periodically alternating wave troughs and wave crests. Preferably, each respective individual conductor—viewed from its conductor layer—lies in a wave trough. In combination with the staggered arrangement in the transverse direction, this results in a particularly compact design, as the individual conductors are virtually brought together in the vertical direction. At the same time, such a compact arrangement is advantageous for the good EMC properties that are sought.

Suitable fastening means are preferably provided for fastening the supply line to a carrier component, in particular a car body component. In particular, fastening means such as clips or hole holders for fastening elements are arranged or formed on the cable duct.

Bracket clips are provided, for example, especially when the cable duct is designed as a profile. In a preferred embodiment, these are also used to hold the individual conductors in the cable duct. The bracket clips are therefore designed to hold the individual conductors in the cable duct and at the same time to fasten them to the carrier component.

As explained at the outset, such a supply line is used in particular as a two-pole DC line. In particular, it is used to transmit high currents of typically several 10 A or even several 100 A. A respective supply line is therefore suitably dimensioned for the transmission of currents oof such magnitude.

The supply line is intended in particular for use in a motor vehicle for non-rail-bound road traffic and is used in a mounted position in such a motor vehicle, in particular a passenger car. The supply line connects two electrical components of a vehicle electrical system of the motor vehicle. The cable duct extends over most (>75%, >90%) of the entire length between the two components. These are, for example, a (first) power distributor/current source on the one hand and a (second) power distributor/consumer on the other. In particular, the supply line is a so-called backbone in the motor vehicle. This generally connects a front section of the motor vehicle with a rear section. It often runs centrally in the motor vehicle, e.g. in a central cable tunnel. In electric-motor-driven vehicles, for example, it is used to supply power to an electric traction drive. For example, it is laid along or on a traction battery, which provides the electrical energy for the traction drive.

One exemplary embodiment of the invention is explained in greater detail below with reference to the figures. These show, in simplified representations:

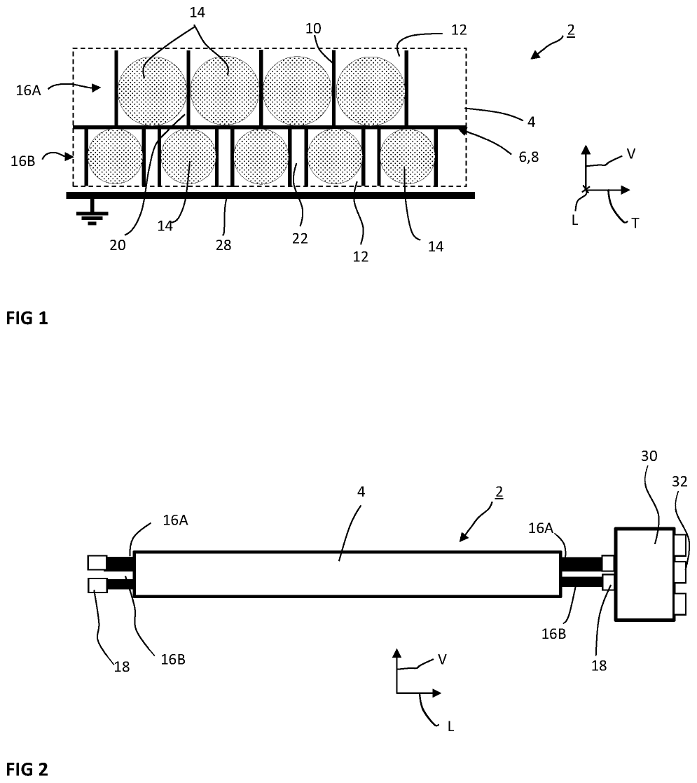

FIG. 1 a cross section through a supply line, and

FIG. 2 a view of a detail of a device having such a supply line.

The supply line 2 shown in the figures has a cable duct 4 made of an insulating material. The supply line 2 generally extends in a longitudinal direction L, a transverse direction T and in a vertical direction V. The cable duct 4 is formed by a base part 6 or has at least one such base part 6, which is designed, for example, as an extruded profile. The cable duct 4 preferably extends over the entire length of the supply line 2, except for the connection regions at the ends. It has an intermediate base 8, from which separating ribs 10 extend on both sides. In the exemplary embodiment shown in FIG. 1, the intermediate base 8 is flat. In particular, the separating ribs 10 are oriented perpendicular to the intermediate base 8. The cable duct 4 therefore has a conductor layer on both sides of the intermediate base 8. A plurality of individual channels 12 are formed on each side of the intermediate base 8 and are bounded by the intermediate base 8 and laterally by separating ribs 10. The individual channels 12 form free receiving spaces and are each open on the side facing away from the intermediate base. Individual conductors 14 are inserted into each of the individual channels 12 and in the exemplary embodiment are formed by round conductors, preferably solid and bare round conductors.

The individual conductors 14 of a respective conductor layer together form a conductor arrangement 16A, 16B. The individual conductors 14 of a respective conductor arrangement 16A, 16B are electrically connected to each other and thus connected in parallel. For this purpose, a common contact element 18 is arranged for each conductor arrangement 16A, 16B—preferably on both sides at the end of the supply line 2 (see in particular FIG. 2 in this regard). The individual conductors 14 of a respective conductor arrangement 16A, 16B are electrically contacted with each other via this common contact element 18. During operation, the two conductor arrangements 16A, 16B are therefore typically at different voltages and thus operating potentials.

The individual channels 12 are preferably generally designed in such a way that a respective individual conductor 14 is clamped in them. For this purpose, the individual channels 12 have, for example, a width that is less than or equal to the width (diameter) of the individual conductors 14. According to one variant, it is additionally or alternatively provided that the individual conductors 14 are snapped into a respective individual channel 12. For this purpose, for example, the separating ribs 10 are suitably designed and have snap-in elements, not shown in detail, at their end facing away from the intermediate base 8.

In principle, it is possible for the cable duct 4 to have, in addition to the base part 6, at least one cover, which can be used to close the individual channels 12 of at least one conductor layer. Such a cover, which is not shown in detail here, is snapped onto the base part, for example.

In the exemplary embodiment of FIG. 1, a special variant is shown in which the individual conductors 14 of a respective conductor arrangement 16A, 16B have different conductor cross sections and thus different diameters. According to FIG. 1, the individual conductors 14 of the upper conductor arrangement 16A have a larger diameter than the individual conductors 14 of the lower conductor arrangement 16B. Furthermore, the individual conductors 14 of the two conductor arrangements 16A, 16B are arranged offset to each other in the transverse direction T.

The individual conductors 14 of the upper conductor layer are directly adjacent to each other, i.e., they are only separated from each other by exactly one separating rib. Due to their design as round conductors, gusset regions 20 are formed between adjacent individual conductors 14. The individual conductors 14 of the second supply line 16B are now offset in the transverse direction T in such a way that they are arranged in the region of these gusset regions 20 and specifically in such a way that a center line of the respective smaller individual conductor 14 is arranged at the transverse position, which—viewed in the transverse direction T—corresponds to the geometric center between two of the larger individual conductors 14.

In order to ensure the desired transverse position of the smaller individual conductors 14, these are held stationary in their desired transverse position by the separating ribs 10. Empty channels 22 are formed to achieve this. These alternate with the individual channels 12 in which the individual conductors 14 are arranged. According to a preferred variant, which is not shown in detail here, the intermediate base 8 is corrugated, specifically in such a way that the individual conductors 14 each come to rest in a wave trough, so that the individual conductors 14 of the two supply lines 2 lie as close together as possible in the vertical direction V.

The supply line 2 is preferably intended for use in a motor vehicle, for example a passenger car. For this purpose, it is routed along a ground plane 28, for example a body component/body panel, in particular a vehicle floor panel, so that a shielding effect is achieved by this ground plane 28. The body component is, for example, the housing of a traction battery for the traction motor of an electric vehicle. The supply line therefore rests on this ground plane with its cable duct 4, wherein the individual channels 12 of the lower conductor arrangement 16B are open downwards to the ground plane 28, for example. For example, the supply line 2 is routed underneath a body floor and therefore outside a passenger compartment. The component referred to as the ground plane 28 indicates an exemplary position of the cable duct 4 in relation to the body mass, which is formed by the vehicle floor panel, for example.

FIG. 2 shows a highly simplified illustration of an application in which one end of the supply line 2 is connected to an electrical component 30, for example a consumer, an inverter, a (second) power distributor, etc. Its other end is connected, for example, to an energy source, especially to a battery or also to a (first) power distributor, etc.

The component 30 is, for example, a (power) distributor on which a plurality of connections 32 are arranged for connecting loads or other electrical components. The component 30 can also be a consumer directly, such as an electric drive motor or an inverter connected upstream of it.

In such a case in particular, the supply line 2 is designed as a so-called backbone.

As can also be seen from FIG. 2, the two conductor arrangements 16A, 16B emerge from the cable duct 4 on both sides in an end connection region in or against the longitudinal direction L. In this emerging partial region, the individual conductors 14 of a respective conductor arrangement 16A, 16B are electrically connected to each other via the contact element 18. On the side facing the component 30, the contact element 18 is designed, for example, as a contact plug, which is therefore connected to the component 30 via a plug connection. In comparison to the remaining length of the supply line 2, the respective connection region has only a short length, for example of at most 20% and in particular at most 10%. The length of the respective connection region is typically at most 20 cm to 40 cm, whereas the total length of the supply line 2 is typically in the range of from 1.5 m to several meters, for example 3 m.

The supply line 2 is preferably used for installation in a motor vehicle. The supply line 2 has, for example, a three-dimensional laying structure, i.e., it can also have inclined and/or curved portions in its longitudinal and extension direction. Alternatively, it is flat over its entire length.

Suitable fastening means are provided for fastening the supply line 2 to a carrier component, in particular a car body component. For example, fastening means such as clips or hole holders for fastening means are arranged or formed on the cable duct.

Especially when the cable duct is designed as a profile, for example, bracket clips are provided which are preferably designed to hold the individual conductors in the duct and at the same time to fasten them to the carrier.

The invention is not limited to the exemplary embodiment described above. Rather, other variants of the invention can also be derived from this by a person skilled in the art without departing from the subject matter of the invention. In particular, all the individual features described in conjunction with the exemplary embodiment can also be combined with one another in other ways without departing from the subject matter of the invention.

### LIST OF REFERENCE SIGNS

2 supply line
4 cable duct
6 base part
8 intermediate floor
10 separating rib
12 individual channel
14 individual conductor
16A, B conductor arrangements
18 contact element
20 gusset region
22 empty channel
28 ground plane
30 component
32 connections
V vertical direction
T transverse direction
L longitudinal direction

1-16. (canceled)

17. An electrical supply line, comprising:
a cable duct having laterals separating ribs; and
two conductor configurations, electrically isolated from one another, for different operating potentials, wherein said two conductor configurations are disposed in one conductor layer each and one above another, wherein each of said two conductor configurations has a plurality of individual conductors and said conductor configurations are guided in said cable duct, said cable duct has for each of said individual conductors an individual channel defined by said lateral separating ribs, and in that said individual conductors are disposed in a stationary manner relative to one another between two of said lateral separating ribs.

18. The electrical supply line according to claim 17, wherein the electrical supply line is configured as a DC line with one of said conductor configurations as a forward conductor and another of said conductor configurations as a return conductor.

19. The electrical supply line according to claim 17, wherein said individual conductors are clamped in their respective said individual channel.

20. The electrical supply line according to claim 17, wherein each said conductor layer has exactly one of said conductor configurations for exactly one operating potential.

21. The electrical supply line according to claim 17, wherein each of said individual conductors of said conductor layer are electrically connected to each other.

22. The electrical supply line according to claim 21, further comprising a common contact element, wherein an electrically conductive connection between said individual conductors is established via an integrally bonded connection or via a mechanical connection of said individual conductors to said common contact element.

23. The electrical supply line according to claim 17, wherein said cable duct is a one-piece cable duct.

24. The electrical supply line according to claim 17, wherein said individual conductors are round conductors.

25. The electrical supply line according to claim 17, wherein said individual conductors are compacted conductors or solid conductors.

26. The electrical supply line according to claim 17, wherein said individual conductors are bare conductors without insulation.

27. The electrical supply line according to claim 17, wherein said individual conductors have different conductor cross sections.

28. The electrical supply line according to claim 17, wherein said individual conductors of a first of said conductor layers have a smaller conductor cross section than said individual conductors of a second of said conductor layers.

29. The electrical supply line according to claim 17, wherein in one of said conductor layers there is formed an empty channel between every two adjacent ones of said individual conductors.

30. The electrical supply line according to claim 17, wherein said individual conductors of a first of said conductor layers are disposed next to each other, forming a gusset region, and said individual conductors of a second of said conductor layers are disposed in regions of said gusset regions.

31. The electrical supply line according to claim 17, wherein said cable duct has an intermediate floor which separates said two conductor configurations from one another, wherein said intermediate floor is corrugated.

32. The electrical supply line according to claim 17, further comprising fastening means disposed on said cable duct for fastening to a carrier component.

33. The electrical supply line according to claim 23, wherein said one-piece cable duct is configured as an extruded profile.

34. The electrical supply line according to claim 28, wherein in said first conductor layer having said individual conductors with the smaller conductor cross section, there is formed an empty channel between every two adjacent ones of said individual conductors.

35. A device, comprising:
an electrical supply line, containing:
a cable duct having laterals separating ribs;
two conductor configurations, electrically isolated from one another, for different operating potentials, wherein said two conductor configurations are disposed in one conductor layer each and one above another, wherein each of said two conductor configurations has a plurality of individual conductors and said conductor configurations are guided in said cable duct, said cable duct has for each of said individual conductors an individual channel defined by said lateral separating ribs, and in that said individual conductors are disposed in a stationary manner relative to one another between two of said lateral separating ribs; and
said conductor configurations are configured to connected to different electrical reference potentials, and a first of said conductor configurations is configured as a forward conductor and a second of said conductor configurations is configured as a return conductor.
